(19) United States
(12) Patent Application Publication
(10) Pub. No.: US 2022/0252884 A1
(43) Pub. Date: Aug. 11, 2022

(54) IMAGING SYSTEM, DISPLAY DEVICE, IMAGING DEVICE, AND CONTROL METHOD FOR IMAGING SYSTEM

(71) Applicant: CANON KABUSHIKI KAISHA, Tokyo (JP)

(72) Inventors: Go Naito, Kanagawa (JP); Shimpei Itagaki, Tokyo (JP); Toru Matsumoto, Kanagawa (JP); Ryuichiro Yasuda, Tokyo (JP)

(21) Appl. No.: 17/592,621

(22) Filed: Feb. 4, 2022

(30) Foreign Application Priority Data
Feb. 10, 2021 (JP) 2021-019734

(51) Int. Cl. G02B 27/01

(52) U.S. Cl. CPC G02B 27/0172; G02B 2027/014; G02B 2027/0138

(57) ABSTRACT

An imaging system including an imaging device and a head-mounted display device, wherein the imaging device includes: an imaging unit configured to control an image sensor; and a display control unit configured to display a captured image captured by the image sensor and an object existing in a virtual space, wherein the display device includes a display control unit to display the object, and wherein, when a display of the imaging device is viewed through the display device, one of the display control unit of the imaging device and the display control unit of the display device displays the object, which has been converted on the basis of information about an imaging state of the imaging device, and the other of the display control unit of the imaging device and the display control unit of the display device does not display the object.

### BACKGROUND OF THE INVENTION

### Field of the Invention

The present invention relates to an imaging system, a display device, an imaging device, and a control method for an imaging system.

### Description of the Related Art

In recent years, research and development in relation to augmented reality (referred to hereafter as AR) technology, in which a real space and a virtual space are seamlessly fused in real time, have been flourishing. Display devices that apply augmented reality technology are known as AR glasses and are gradually being put to practical use.

AR glasses are capable of displaying objects (referred to hereafter as AR content) existing in a virtual space so as to be superimposed on a real space. By displaying AR content, AR glasses allow a user to perceive the AR content as if the AR content were appearing in the real space.

Further, in recent years, with improvements in the performance of imaging devices, products that superimpose AR content on images captured by imaging devices have begun to appear. Japanese Patent No. 6715441 discloses technology in which an imaging device converts AR content received from a cloud on the basis of the attitude of the imaging device and displays the converted AR content so as to be superimposed on a display image on the imaging device.

AR glasses display the AR content so as to be superimposed in alignment with an object, such as a person, an animal, or a thing in a real space, or a background. Hence, when a user wearing the AR glasses views a display screen of the imaging device, the display state may not be that intended by the user.

In order to display the AR content displayed on the AR glasses so as to be superimposed in alignment with the real space, the display state, such as the display position, thereof is converted. Since the AR content is converted so as to be aligned with the real space, a display space of the AR content displayed on the AR glasses deviates from a display space of the display screen of the imaging device.

Therefore, when the user views the display screen of the imaging device while wearing the AR glasses, a problem occurs in that the AR content displayed on the AR glasses is not displayed when aligned with the display screen of the imaging device. Further, when the display screen of the imaging device is viewed through the AR glasses and the AR content is also displayed on the display screen of the imaging device, the AR content may be displayed in double on the imaging device and the AR glasses.

### SUMMARY OF THE INVENTION

The present invention provides an imaging system to present AR content that has been aligned with a captured image captured by an imaging device to a user wearing AR glasses when the user views a display screen of the imaging device without causing a feeling of discomfort.

An imaging system according to the present invention is an imaging system including an imaging device and a display device that is a head-mounted device, wherein the imaging device comprises at least one processor or at least one circuit which function as: an imaging unit configured to control an image sensor; and a display control unit configured to display a captured image captured by the image sensor and an object existing in a virtual space, wherein the display device comprises at least one processor or at least one circuit which function as a display control unit to display the object, and wherein, when a display of the imaging device is viewed through the display device, one of the display control unit of the imaging device and the display control unit of the display device displays the object, which has been converted on the basis of information about an imaging state of the imaging device, and the other of the display control unit of the imaging device and the display control unit of the display device does not display the object.

Further features of the present invention will become apparent from the following description of exemplary embodiments with reference to the attached drawings.

### BRIEF DESCRIPTION OF THE DRAWINGS

FIGS. 1A and 1B are a schematic view and a block diagram of an imaging system;

FIGS. 2A to 2C are views illustrating displays on an imaging device and a display device;

FIGS. 3A to 3D are views illustrating the display of AR content according to a first embodiment;

FIG. 4 is a flowchart showing display processing according to the first embodiment;

FIGS. 5A to 5C are views illustrating a modified example of the first embodiment;

FIG. 6 is a flowchart showing display processing according to a second embodiment; and

FIG. 7 is a flowchart showing display processing according to a third embodiment.

### DESCRIPTION OF THE EMBODIMENTS

### First Embodiment

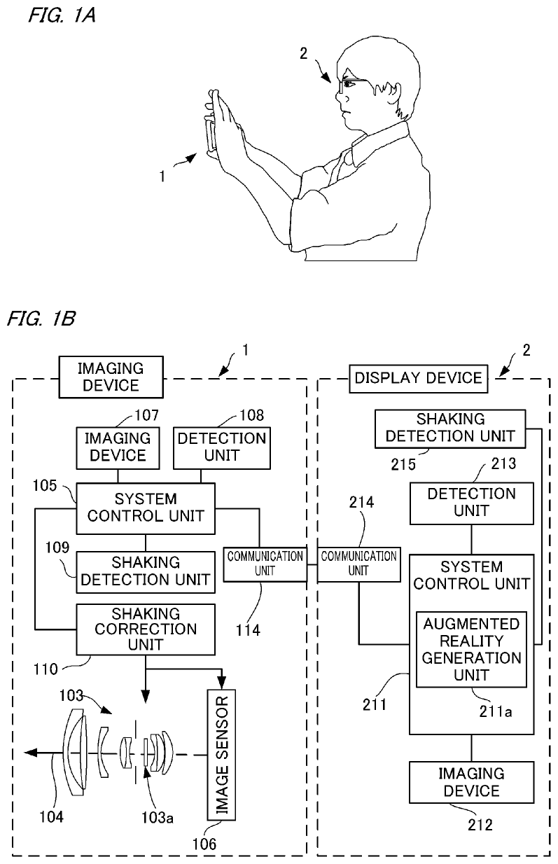

Embodiments of the present invention will be described below with reference to the figures. FIGS. 1A and 1B to FIGS. 5A to 5C are views illustrating an imaging system according to a first embodiment.

Device Configuration: FIG. 1A is a schematic view of the imaging system according to this embodiment. The imaging system includes an imaging device 1 and a head-mounted display device (an HMD: Head Mounted Display) 2. The head-mounted display device 2 may be constituted not only by goggles or glasses but also by pince-nez or contact lenses. In FIG. 1A, a user is wearing AR glasses serving as the display device 2 and holding a smartphone serving as the imaging device 1. The user is viewing a display screen of the imaging device 1 through the display device 2. FIG. 1B is an example block diagram of the imaging device 1 and the display device 2 included in the imaging system.

The imaging device 1 is an electronic device capable of displaying captured images (live view images), such as a smartphone or a camera, for example. The display device 2 is an augmented reality display device capable of displaying AR content (objects existing in a virtual space), such as AR glasses, for example. An optical see-through HMD using a transparent display is envisaged as the AR glasses according to this embodiment, but a video see-through HMD that videos the outside world and synthesizes the video electronically with video of a virtual world may also be used. Note that hereafter, the imaging device 1 will be described as a smartphone 1 and the display device 2 will be described as AR glasses 2.

Referring to FIG. 1B, first, the configuration of the smartphone (the imaging device) 1 will be described. An imaging optical system 103 is constituted by a plurality of lenses. When camera shake is detected, an image stabilization lens 103a corrects an optical axis 104 by moving in a direction for canceling out the shaking.

A system control unit 105 is a control unit constituted by at least one processor or at least one circuit in order to perform overall control of the smartphone 1. The system control unit 105 realizes the processing of this embodiment by executing a program stored in a nonvolatile memory (not shown). More specifically, the system control unit 105, serving as an imaging unit, executes imaging processing by controlling an image sensor 106 and so on. Further, serving as a display control unit, the system control unit 105 controls the display on a display unit (display) 107. Furthermore, serving as a detection unit, the system control unit 105 detects that the display unit 107 of the smartphone 1 is being viewed through the AR glasses 2.

The image sensor 106 is constituted by a CCD, a CMOS element, or the like that converts an optical image into an electric signal. The display unit 107 is a display unit provided on the smartphone 1 in order to display images and various information. The display unit 107 is a liquid crystal monitor or the like, for example.

A detection unit 108 detects signals from an operating unit including a shutter release button and so on, not shown in the figures, and detects that the user has viewed the display unit 107 of the smartphone 1 through the AR glasses 2 and so on. A shaking detection unit 109 detects the state of shaking of the smartphone 1. When camera shake is detected by the shaking detection unit 109, a shaking correction unit 110 corrects the shaking by moving the image stabilization lens 103a.

A communication unit 114 is a wired or wireless communication interface capable of transmitting data between the system control unit 105 and a system control unit 211. The communication unit 114 transmits captured images, information about the imaging state, and so on to the AR glasses 2. The imaging state is information indicating the attitude, focal length, and field depth of the smartphone 1, for example. Further, the communication unit 114 receives AR content, information indicating the attitude of the AR glasses 2, and so on from the AR glasses 2.

The smartphone 1 may include a plurality of imaging units (cameras), each including the imaging optical system 103 and the image sensor 106. For example, the smartphone 1 may include a front surface camera for photographing a photographer side and a rear surface camera for photographing a subject side.

Next, referring to FIG. 1B, the configuration of the AR glasses (the display device) 2 will be described. The system control unit 211 is a control unit constituted by at least one processor or at least one circuit in order to perform overall control of the AR glasses 2. The system control unit 211 realizes the processing of this embodiment by executing a program stored in a nonvolatile memory (not shown). More specifically, the system control unit 211, serving as a display control unit, controls the generation, conversion, and display of AR content. Further, serving as a detection unit, the system control unit 211 detects that the display unit 107 of the smartphone 1 is being viewed through a display unit 212 of the AR glasses 2. An augmented reality generation unit 211a generates the AR content.

The display unit 212 corresponds to a glasses part of the AR glasses 2. A detection unit 213 detects signals from an operating unit, not shown in the figures, provided on the AR glasses 2, and detects that the user has viewed the display unit 107 of the smartphone 1 through the AR glasses 2 and so on. The detection unit 213 also detects the peripheral environment of the AR glasses 2. For example, the AR glasses 2 detect the state of the peripheral environment using a small camera or the like, and generate data that are used to convert the AR content into an appropriate display state. Conversion of the display state includes, for example, coordinate conversion based on information relating to shaking of the smartphone 1 and the AR glasses 2, conversion of the orientation and size of the AR content, and so on.

A communication unit 214 is a wired or wireless communication interface capable of transmitting data between the system control unit 105 and the system control unit 211. The communication unit 214 receives captured images, information about the imaging state, and so on from the smartphone 1. The imaging state is information indicating the attitude, focal length, and field depth of the smartphone 1, for example. Further, the communication unit 214 transmits the AR content, information indicating the attitude of the AR glasses 2, and so on to the smartphone 1. A shaking detection unit 215 detects the shaking state of the AR glasses 2.

The imaging system including the smartphone 1 and the AR glasses 2 shown in FIG. 1A displays a captured image and AR content without causing a feeling of discomfort when the user views the display unit 107 of the smartphone 1 serving as the imaging device through the display unit 212 of the AR glasses 2.

When the user uses the AR glasses 2 alone, the AR content generated by the augmented reality generation unit 211a is displayed on the display unit 212 in alignment with the peripheral environment detected by the detection unit 213.

In this embodiment, when the user views the display unit 107 while holding the camera of the smartphone 1, the AR content generated by the augmented reality generation unit 211a is transmitted to the smartphone 1 through the communication unit 214 and the communication unit 114. The AR content transmitted to the smartphone 1 is converted in accordance with the imaging state of the smartphone 1 and displayed on the display unit 107. The imaging state is constituted by focus (field depth) information, focal length information, information indicating the respective attitudes of the smartphone 1 and the AR glasses 2, and so on, for example. The shaking states of the smartphone 1 and the AR glasses 2 can be acquired on the basis of the information indicating the respective attitudes of the smartphone 1 and the AR glasses 2.

The shaking state of the AR glasses 2 (the shaking state of the head) and the shaking state of the camera are different, and therefore the AR content is corrected on the basis of the attitude information of the AR glasses 2 in order to suppress blurring caused by movement of the AR glasses 2. In the smartphone 1, AR content acquired by correcting the shaking state of the AR glasses 2 is further corrected on the basis of the shaking state of the smartphone 1 and then displayed on the display unit 107.

Note that the display state of the AR content may be converted either by the AR glasses 2 or by the smartphone 1. When the AR content is converted by the AR glasses 2, the AR glasses 2 receive the captured image and the imaging state from the smartphone 1. The AR glasses 2 then convert the coordinates of the AR content, the focus state, and the camera shake state on the basis of the received imaging state in alignment with the captured image, thereby generating the AR content to be displayed by the smartphone 1. The AR glasses 2 then transmit the generated AR content to the smartphone 1. The smartphone 1 displays the AR content received from the AR glasses 2 on the display unit 107.

Alternatively, when the AR content is converted by the smartphone 1, the AR glasses 2 transmit the AR content generated by the augmented reality generation unit 211a and the attitude information of the AR glasses 2 to the smartphone 1. The smartphone 1 corrects blurring of the AR content caused by movement of the AR glasses 2 on the basis of the received attitude information of the AR glasses 2. The smartphone 1 also corrects the AR content on the basis of the attitude information, focal length, and field depth information of the camera and displays the corrected AR content on the display unit 107.

Since the AR content is displayed on the display unit 107 in accordance with the imaging state of the smartphone 1, the smartphone 1 can perform image capture in a state where the AR content is appropriately superimposed on the captured image. Further, the AR glasses 2 stop displaying the AR content on the display unit 212. Thus, double display of the AR content on the display unit 107 of the smartphone 1 and the display unit 212 of the AR glasses 2 is avoided, and as a result, the AR content is displayed so as to be superimposed on the captured image without causing a feeling of discomfort. Note that when the AR glasses 2 stop displaying the AR content, the AR glasses 2 may be controlled so as not to stop displaying content (for example, an indicator, an operation menu, information display, and so on) other than the AR content on the display unit 212.

Note that although the AR content was described as being generated by the augmented reality generation unit 211a, the AR content does not have to be generated by the AR glasses 2. Instead of being generated by the AR glasses 2, the AR content may be generated by a smartphone or another external device (a PC, a cloud server device, or the like). When the AR content is generated by an external device (a smartphone, a PC, a cloud server device, or the like), there is no need to install a large, high-performance SoC (System-on-a-chip) in the AR glasses 2, and as a result, the AR glasses 2 can be reduced in size (formed in the shape of glasses rather than goggles).

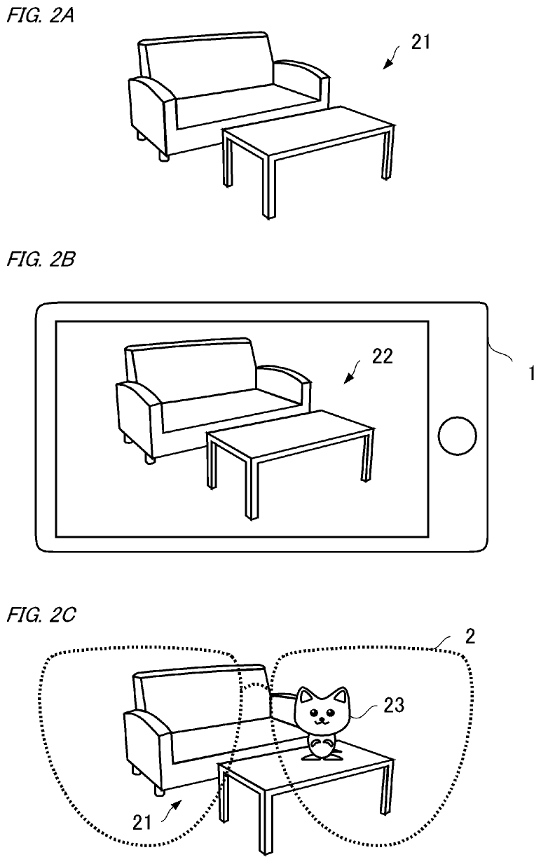

Screen Displays: Referring to FIGS. 2A to 2C, screen displays on the smartphone 1 and the AR glasses 2 will be described. FIG. 2A shows a background of a real space, on which a subject 21 (a table and a sofa) existing in the real space is placed.

FIG. 2B shows the subject 21 shown in FIG. 2A as viewed through the camera of the smartphone 1. A subject image 22 is a captured image of the subject, displayed on the display unit 107 of the smartphone 1. When the user holds the camera of the smartphone 1 against the subject 21, the subject 21 is captured by the image sensor 106 through the imaging optical system 103. The system control unit 105 displays the subject image 22 on the display unit 107 by performing development processing and the like on the electric signal output from the image sensor 106.

FIG. 2B is a live view image that is displayed by activating the camera of the smartphone 1 and orienting the lens toward the subject 21. The live view image displayed on the display unit 107 is captured by an imaging operation performed by the camera of the smartphone 1.

FIG. 2C shows the subject 21 shown in FIG. 2A as viewed through the AR glasses 2. AR content 23 is a character generated by the augmented reality generation unit 211a. When the user views the subject 21 through the AR glasses 2, the AR content 23 is converted by the system control unit 211 so as to be aligned with the peripheral environment and displayed on the display unit 212.

Conversion for the purpose of alignment with the peripheral environment is realized by modifying the display state, such as the display position and size, of the AR content in accordance with the shaking state of the AR glasses 2, detected by the shaking detection unit 215, and so on, for example. The AR content is displayed on the display unit 212 when the user wearing the AR glasses 2 activates the AR glasses 2 and looks at the subject 21. When the user moves or looks at the subject 21 from a different angle, the AR content 23 is displayed on the display unit 212 after the display state thereof has been modified in alignment with the peripheral environment seen through the display unit 212 of the AR glasses 2.

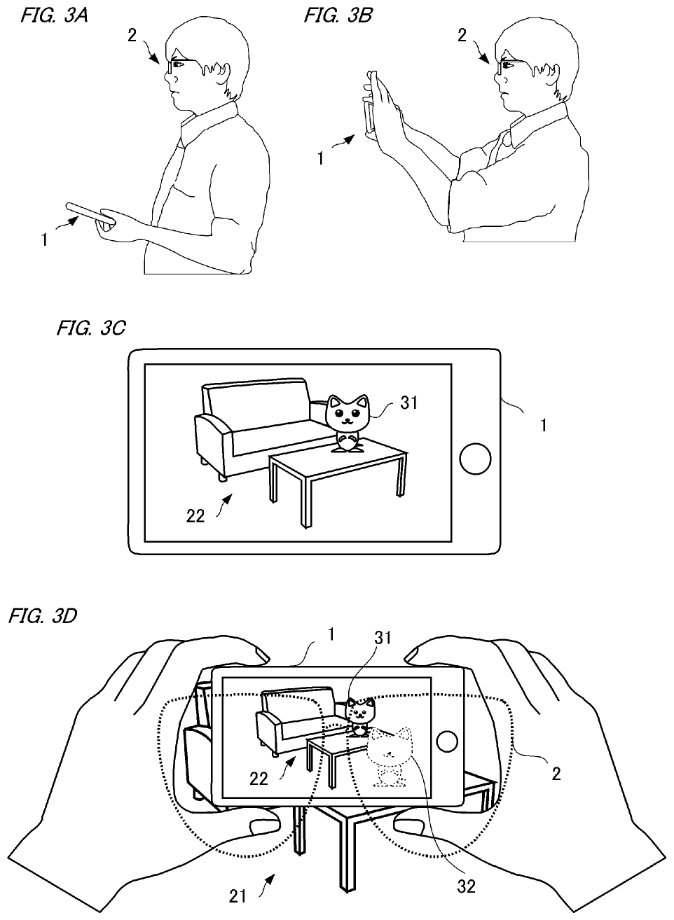

Referring to FIGS. 3A to 3D, display in a case where the display unit 107 of the smartphone 1 is viewed through the display unit 212 of the AR glasses 2 will be described. A condition in which the display unit 107 of the smartphone 1 is being viewed through the display unit 212 of the AR glasses 2 is detected by the detection unit 108 of the smartphone 1 or the detection unit 213 of the AR glasses 2.

The detection unit 108 of the smartphone 1 detects the AR glasses 2 from an image captured by the front surface camera of the smartphone 1 on the basis of an image and feature data of the AR glasses 2, which are recorded in advance in a storage unit (not shown) of the smartphone 1, for example. When the detection unit 108 detects the AR glasses 2 from the image captured by the front surface camera, the detection unit 108 can detect that the display unit 107 is being viewed. In this specification, as regards the term “detect that . . . is being viewed”, it is sufficient to be able to detect that the user is actually viewing, and as noted above, this term also includes simply detecting the AR glasses 2 from the image captured by the front surface camera.

Further, the detection unit 213 of the AR glasses 2 includes a camera for detecting the peripheral environment and detects the smartphone 1 from the image captured by the camera. The detection unit 213 detects the smartphone 1 from the image captured by the camera of the AR glasses 2 on the basis of an image and feature data of the smartphone 1, which are recorded in advance in a storage unit (not shown) of the AR glasses 2, for example. When the detection unit 213 detects the smartphone 1 from the image captured by the camera of the AR glasses 2, the detection unit 213 can detect that the display unit 107 is being viewed through the display unit 212.

Furthermore, the detection unit 213 of the AR glasses 2 is not limited to having a camera, and instead may have a function enabling acquisition of a captured image (a distance image) of the subject. For example, the detection unit 213 may include a LIDAR (Laser Imaging Detection and Ranging) sensor, and may detect the smartphone 1 using the LIDAR sensor.

Note that the condition in which the display unit 107 of the smartphone 1 is being viewed through the display unit 212 of the AR glasses 2 may be detected by the detection unit 213 of the AR glasses 2 alone, and the detection result may be transmitted to the smartphone 1 via the communication unit 214 and the communication unit 114. Similarly, the condition may be detected by the detection unit 108 of the smartphone 1 alone, and the detection result may be transmitted to the smartphone 1 via the communication unit 114 and the communication unit 214. In these cases, the system control unit 105 or the system control unit 211 determines whether or not the user is viewing the display unit 107 of the smartphone 1 through the display unit 212 of the AR glasses 2 on the basis of the received detection result.

FIG. 3A shows a state in which the user is not looking at the smartphone 1 while viewing the subject 21 through the AR glasses 2. FIG. 3B shows a state in which the user holds the smartphone 1 as a camera from the state in FIG. 3A. In FIG. 3B, the user is viewing the display unit 107 of the smartphone 1 through the display unit 212 of the AR glasses 2 and thereby viewing the subject 21 through the AR glasses 2 and the camera of the smartphone 1.

FIG. 3C shows content displayed on the display unit 107 when the user holds the camera of the smartphone 1 in the state as in FIG. 3B and photographs the subject. The display unit 107 of the smartphone 1 displays the subject image 22 and a character serving as AR content 31. As shown in FIG. 2B, the subject image 22 is a captured image of the subject 21, captured by the camera of the smartphone 1, and is displayed on the display unit 107 of the smartphone 1. The AR content 31 is a character serving as AR content displayed on the display unit 107 of the smartphone 1.

The AR content 31 is content that is displayed on the display unit 107 by converting the display state of the AR content 23 generated by the augmented reality generation unit 211a, shown in FIG. 2C. The system control unit 105 receives information about the AR content 23 from the AR glasses 2 via the communication unit 114 and the communication unit 214. The system control unit 105 converts the AR content 23 on the basis of an imaging state (including relative positions, orientations, and so on of the camera and the subject) acquired by the shaking detection unit 109 and so on of the smartphone 1, and displays the converted content on the display unit 107.

Thus, the AR content 23 superimposed on the subject 21 as seen through the AR glasses 2 is converted into the AR content 31 (the character) superimposed on the subject 21 as seen through the camera of the smartphone 1.

FIG. 3D is a view showing the display unit 212 of the AR glasses 2 superimposed on the display unit 107 of the smartphone 1 in FIG. 3C. Similarly to FIG. 3C, the display unit 107 of the smartphone 1 displays the AR content 31 converted in accordance with the imaging state of the camera of the smartphone 1.

AR content 32 is displayed in a display state corresponding to a case in which the peripheral environment is viewed through the AR glasses 2 alone. Further, in actuality, the AR content 32 is set so as not to be displayed by the display unit 212 of the AR glasses 2 and is therefore indicated by dotted lines in FIG. 3D. By not displaying the AR content 32, the system control unit 211 performs control to ensure that the character (the AR content) is not displayed in double on the display unit 107 of the smartphone 1 and the display unit 212 of the AR glasses 2.

Note that although in FIG. 3D, the character is not displayed by the display unit 212 of the AR glasses 2, this embodiment is not limited thereto. For example, when the AR content displayed on the display unit 212 is larger than the smartphone 1, the system control unit 211 may recognize the shape of the smartphone 1 and not display an area of the AR content displayed on the display unit 212 that overlaps the smartphone 1.

As described above, the smartphone 1 displays data of the AR content received from the AR glasses 2 on the display unit 107 after converting the data so as to be aligned with the subject of the captured image, and the AR glasses 2 stop displaying the AR content on the display unit 212. As a result, the smartphone 1 can display the AR content in alignment with the captured image. Further, the AR content is not displayed in double on the display unit 107 and the display unit 212, and therefore the user can view the AR content superimposed on the captured image without feeling discomfort.

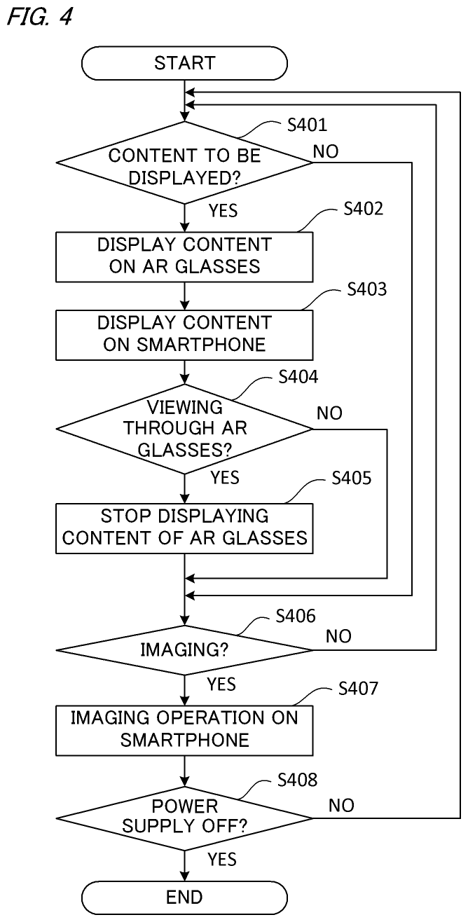

Display Processing of First Embodiment: Referring to FIG. 4, processing for displaying the AR content will be described. FIG. 4 is a flowchart showing AR content display processing according to the first embodiment. The display processing shown in FIG. 4 is started by switching on a power supply of the AR glasses 2.

In step S401, the system control unit 211 determines whether or not to display AR content (also referred to hereafter as content) on the display unit 212 of the AR glasses 2. When content is to be displayed on the display unit 212 of the AR glasses 2, the processing advances to step S402. When content is not to be displayed on the display unit 212 of the AR glasses 2, the processing advances to step S406.

As the determination method of S401, for example, the system control unit 211 determines whether or not content is to be displayed in response to a command (an operation) from the user. More specifically, when a mode for displaying AR content is set by a user operation or the like, the system control unit 211 can determine that content is to be displayed. Alternatively, the system control unit 211 may determine that content is to be displayed when information about AR content disposed in the peripheral environment is detected.

In step S402, the system control unit 211 displays the content on the display unit 212 of the AR glasses 2. In step S403, the system control unit 211 transmits information about the AR content to the smartphone 1. The system control unit 105 of the smartphone 1 converts the received AR content in accordance with the imaging state and displays the converted content on the display unit 107. The system control unit 105 converts the AR content to be displayed on the display unit 107 so that the size, position, and orientation of the AR content relative to the subject are the same as when the AR content is viewed through the AR glasses 2.

In step S404, the system control unit 211 determines whether or not the user is viewing the display unit 107 of the smartphone 1 through the display unit 212 of the AR glasses 2. When the user is viewing the display unit 107 through the display unit 212 of the AR glasses 2, the processing advances to step S405, and when the user is not viewing the display unit 107 through the display unit 212 of the AR glasses 2, the processing advances to step S406.

Note that the determination of step S404 may also be made by the system control unit 105 of the smartphone 1. Further, in step S404, whether or not the user is viewing the display unit 107 through the display unit 212 of the AR glasses 2 may be determined on the basis of an operation performed by the user on the operating unit of the smartphone 1 or the AR glasses 2. For example, the operation performed by the user is an operation to set or cancel a mode for viewing the display unit 107 through the display unit 212 of the AR glasses 2.

Alternatively, the detection unit 108 of the smartphone 1 or the detection unit 213 of the AR glasses 2 may automatically detect whether or not the display unit 107 is being viewed through the display unit 212 of the AR glasses 2. In this case, the system control unit 211 can determine whether or not the user is viewing the display unit 107 through the display unit 212 of the AR glasses 2 in accordance with the detection result.

In step S405, the system control unit 211 stops displaying the AR content on the display unit 212 of the AR glasses 2. The system control unit 211 may stop displaying a partial area of the AR content displayed on the display unit 212 that overlaps the smartphone 1.

Note that when the system control unit 105 of the smartphone 1 performs the determination of step S404, the system control unit 211 may receive the determination result indicating that the display unit 107 is being viewed through the display unit 212 of the AR glasses 2 from the smartphone 1. The system control unit 211 can then stop displaying the AR content on the display unit 212 upon receipt of the determination result.

In step S406, the system control unit 105 determines whether or not an imaging command operation has been performed on the smartphone 1 by the user. When an imaging command operation has been performed, the processing advances to step S407. When an imaging command operation has not been performed, the processing returns to step S401.

In step S407, the system control unit 105 performs an imaging operation using the camera function of the smartphone 1. When AR content is displayed on the display unit 107 of the smartphone 1, the smartphone 1 can capture an image on which the AR content is superimposed by means of the imaging operation.

In step S408, the system control unit 211 determines whether or not the user has switched off the power supply of the AR glasses 2 using an operating unit such as a power supply button. When the user has switched off the power supply of the AR glasses 2, the processing shown in FIG. 4 is terminated. When the user has not switched off the power supply of the AR glasses 2, the processing returns to step S401.

In the AR content display processing shown in FIG. 4, the data of the AR content are transmitted to the smartphone 1 from the AR glasses 2. The smartphone 1 converts the received AR content on the basis of the imaging state of the smartphone 1 and displays the converted content on the display unit 107. Further, while the display unit 107 of the smartphone 1 is being viewed through the display unit 212 of the AR glasses 2, the AR glasses 2 stop displaying the AR content on the display unit 212.

Thus, when the display unit 107 of the smartphone 1 is being viewed through the display unit 212 of the AR glasses 2, the smartphone 1 can display the AR content in alignment with the captured image (the live view image) displayed on the display unit 107 without causing a feeling of discomfort.

Modified Example: The first embodiment was described envisaging a smartphone as the imaging device 1, but this invention is not limited thereto, and in a modified example, a camera is envisaged as the imaging device 1. When the imaging device 1 is a camera, the display unit 107 provided in the imaging device 1 is a back surface liquid crystal screen of the camera, an EVF (electronic viewfinder) provided in the viewfinder of the camera, or the like.

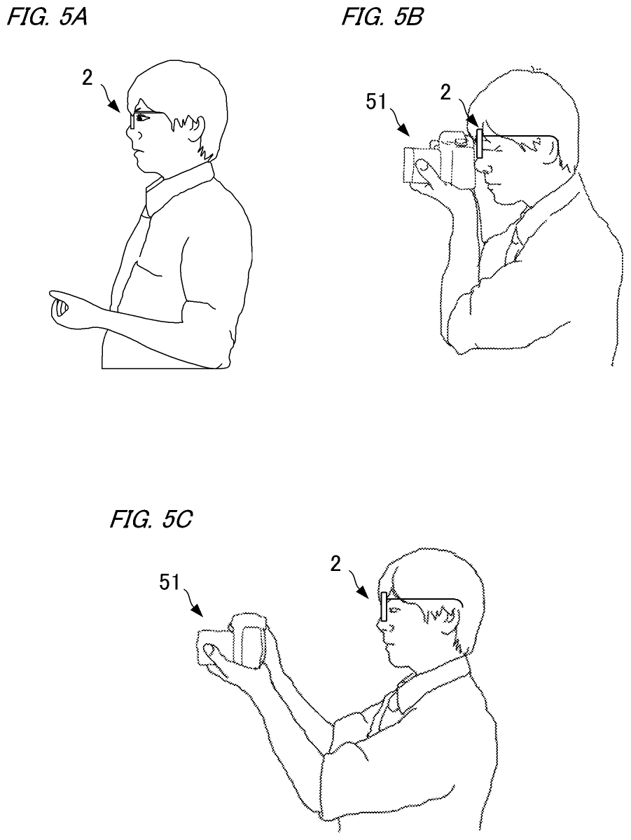

FIGS. 5A to 5C are views illustrating the modified example of the first embodiment. In this modified example of the first embodiment, the imaging device 1 is a camera 51. FIGS. 5B and 5C show states in which the display unit 107 of the camera 51 is being viewed through the display unit 212 of the AR glasses 2.

FIG. 5A, similarly to FIG. 3A, shows the AR content being viewed using the AR glasses 2. FIG. 5B shows a state in which the camera 51 is held from the state in FIG. 5A. In FIG. 5B, the user is looking through the EVF of the camera 51 while wearing the AR glasses 2. Similarly to the case shown in FIG. 3B, the user looks through the EVF of the camera 51 through the display unit 212 of the AR glasses 2.

Accordingly, the display state of the AR content is converted so as to be aligned with the image displayed on the EVF serving as the display unit 107 of the imaging device 1. Similarly to the case shown in FIGS. 3A to 3D, the camera 51 receives the data of the AR content by communicating with the AR glasses 2, converts the AR content in accordance with the imaging state, and displays the converted content on the EVF. Further, the AR glasses 2 stop displaying the AR content on the display unit 212. As a result, the imaging device 1 can display the AR content appropriately on the display unit 107.

FIG. 5C shows a state in which back surface liquid crystal of the camera 51 is used as the display unit 107 of the imaging device 1. Similarly to the cases shown in FIGS. 3B and 5B, the camera 51 can display AR content converted so as to be aligned with the captured image on the display unit 107 by communicating with the AR glasses 2.

In the first embodiment, when the display unit 107 of the imaging device 1 is being viewed through the display unit 212 of the AR glasses 2, the smartphone 1 can present AR content that has been aligned with the captured image displayed on the display screen (the display unit 107) to the user without causing a feeling of discomfort.

### Second Embodiment

In the first embodiment, the captured image and the AR content are displayed on the display unit 107 of the smartphone 1 and not displayed on the display unit 212 of the AR glasses 2. In a second embodiment, on the other hand, the captured image and the AR content are displayed on the display unit 212 of the AR glasses 2 and not displayed on the display unit 107 of the smartphone 1.

In other words, in the second embodiment, the display content displayed on the display unit 107 of the smartphone 1 and the display unit 212 of the AR glasses 2 differs from the first embodiment. Note that the device configurations of the smartphone 1 and the AR glasses 2 are similar to the first embodiment. Processing and so on differing from the first embodiment will be described in detail below.

In the second embodiment, when the display unit 107 of the smartphone 1 is being viewed through the display unit 212 of the AR glasses 2, the smartphone 1 stops the display on the display unit 107. Further, the AR glasses 2 display the display content (the captured image) of the display unit 107 on the display unit 212 together with the AR content. The second embodiment is particularly useful in a case where an EVF is used as the display unit 107 of the imaging device 1 (the camera 51), as shown in FIG. 5B.

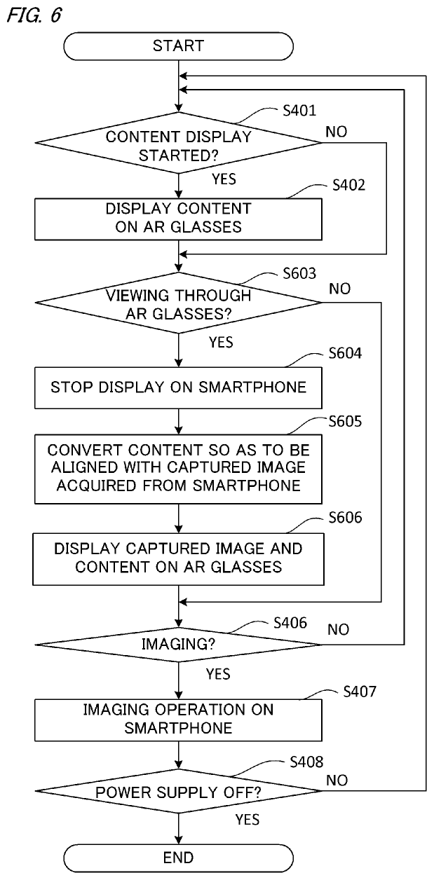

Display Processing of Second Embodiment: Referring to FIG. 6, processing for displaying the AR content will be described. FIG. 6 is a flowchart showing AR content display processing according to the second embodiment. The display processing shown in FIG. 6 is started by switching on the power supply of the AR glasses 2. Identical processing to the processing shown in FIG. 4 has been allocated identical reference symbols, and detailed description thereof has been omitted.

When content is to be displayed on the AR glasses in step S402, the processing advances to step S603. In step S603, similarly to step S404, the system control unit 211 determines whether or not the user is viewing the display unit 107 of the smartphone 1 through the display unit 212 of the AR glasses 2. When the user is viewing the display unit 107 through the display unit 212 of the AR glasses 2, the processing advances to step S604. When the user is not viewing the display unit 107 through the display unit 212 of the AR glasses 2, the processing advances to step S406.

In step S604, the system control unit 211 notifies the smartphone 1 that the display unit 107 of the smartphone 1 is being viewed through the display unit 212 of the AR glasses 2. Having received this notification from the AR glasses 2, the system control unit 105 stops displaying the captured image on the display unit 107. Note that when the system control unit 105 of the smartphone 1 performs the determination of step S403, the system control unit 105 may stop the display on the display unit 107 without communicating with the AR glasses 2.

In step S605, the system control unit 211 communicates with the system control unit 105 in order to acquire data such as the captured image acquired by the camera of the smartphone 1 and the imaging state. On the basis of the data acquired from the smartphone 1, the system control unit 211 converts the size, position, and orientation of the AR content so as to be aligned with the captured image.

In step S606, the system control unit 211 displays a superimposed image in which the converted AR content is superimposed on the captured image on the display unit 212. The system control unit 211 displays the superimposed image in which the AR content is superimposed on the captured image on the display unit 212 in a position corresponding to the display unit 107 of the smartphone 1, this position having been detected by the detection unit 213. The processing from step S406 to step S408 is similar to FIG. 4.

In the AR content display processing shown in FIG. 6, in contrast to the first embodiment, the data relating to the captured image and the imaging state of the smartphone 1 are transmitted to the AR glasses 2 from the smartphone 1. The AR glasses 2 convert the AR content so as to be aligned with the captured image on the basis of the received data. The AR glasses 2 then superimpose the converted AR content on the captured image and display the result on the display unit 212. Further, while the display unit 107 of the smartphone 1 is being viewed through the display unit 212 of the AR glasses 2, the smartphone 1 stops displaying the captured image on the display unit 107.

Thus, when the display unit 107 of the smartphone 1 is being viewed through the display unit 212 of the AR glasses 2, the AR glasses 2 can present AR content that has been aligned with the image captured by the smartphone 1 to the user without causing a feeling of discomfort.

In the second embodiment, when the display unit 107 of the smartphone 1 is being viewed through the display unit 212 of the AR glasses 2, the AR glasses 2 can present AR content that has been aligned with the captured image received from the smartphone 1 to the user without causing a feeling of discomfort.

### Third Embodiment

In the first embodiment, the captured image and the AR content are displayed on the display unit 107 of the smartphone 1. Further, in the second embodiment, the captured image and the AR content are displayed on the display unit 212 of the AR glasses 2. In a third embodiment, on the other hand, the captured image is displayed on the display unit 107 of the smartphone 1, while the AR content is converted so as to be aligned with the captured image and displayed on the display unit 212 of the AR glasses 2.

In other words, in the third embodiment, the display content displayed on the display unit 107 of the smartphone 1 and the display unit 212 of the AR glasses 2 differs from the first embodiment and the second embodiment. Note that the device configurations of the smartphone 1 and the AR glasses 2 are similar to the first embodiment. Processing and so on differing from the first embodiment will be described in detail below.

In the third embodiment, when the display unit 107 of the smartphone 1 is being viewed through the display unit 212 of the AR glasses 2, the smartphone 1 leaves the state in which the captured image is displayed on the display unit 107 unchanged. Further, the AR glasses 2 convert the AR content so as to be aligned with the captured image displayed on the display unit 107 and display the converted AR content on the display unit 212.

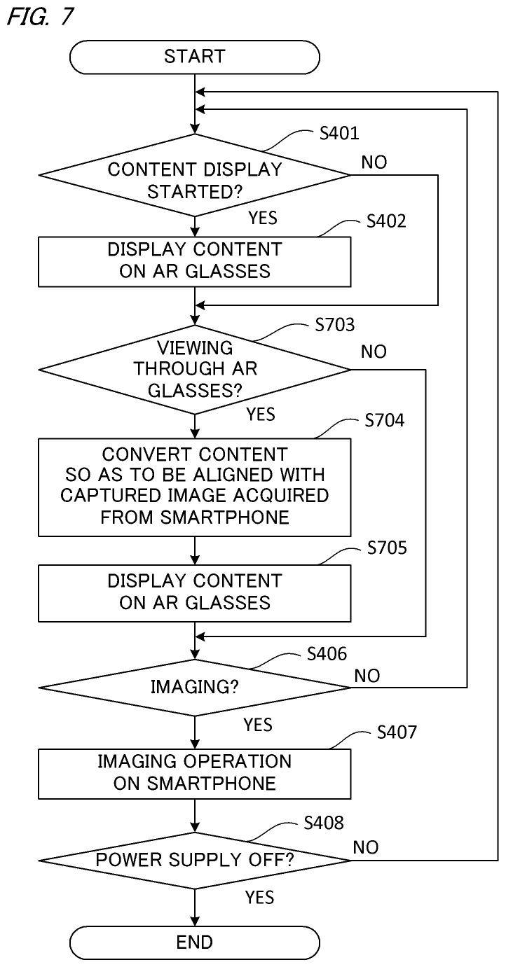

Display Processing of Third Embodiment: Referring to FIG. 7, processing for displaying the AR content will be described. FIG. 7 is a flowchart showing AR content display processing according to the third embodiment. The display processing shown in FIG. 7 is started by switching on the power supply of the AR glasses 2. Identical processing to the processing shown in FIG. 4 has been allocated identical reference symbols, and detailed description thereof has been omitted.

When content is to be displayed on the AR glasses in step S402, the processing advances to step S703. In step S703, similarly to step S404, the system control unit 211 determines whether or not the user is viewing the display unit 107 of the smartphone 1 through the display unit 212 of the AR glasses 2. When the user is viewing the display unit 107 through the display unit 212 of the AR glasses 2, the processing advances to step S704. When the user is not viewing the display unit 107 through the display unit 212 of the AR glasses 2, the processing advances to step S406.

In step S704, similarly to step S605, the system control unit 211 communicates with the system control unit 105 in order to acquire data such as the captured image acquired by the camera of the smartphone 1 and the imaging state. On the basis of the data acquired from the smartphone 1, the system control unit 211 converts the AR content in alignment with the captured image.

In step S705, the system control unit 211 detects the position of the display unit 107 of the smartphone 1 on the display unit 212. The system control unit 211 displays the converted AR content on the display unit 212 in alignment with the position of the display unit 107 of the smartphone 1 on the display unit 212. In other words, the converted AR content is displayed on the display unit 212 so as to be superimposed on the captured image displayed on the display unit 107 of the smartphone 1. The processing from step S406 to step S408 is similar to FIG. 4.

In the AR content display processing shown in FIG. 7, in contrast to the first and second embodiments, the image captured by the smartphone 1 is displayed on the display unit 107 of the smartphone 1, and the AR content is displayed on the display unit 212 of the AR glasses 2. The AR content is converted so as to be aligned with the captured image displayed on the display unit 107 of the smartphone 1 and displayed on the display unit 212 of the AR glasses 2. Hence, when the display unit 107 of the smartphone 1 is being viewed through the display unit 212 of the AR glasses 2, the smartphone 1 and the AR glasses 2 can present AR content that has been aligned with the image captured by the smartphone 1 to the user.

In the third embodiment, when the display unit 107 of the smartphone 1 is being viewed through the display unit 212 of the AR glasses 2, the AR glasses 2 can present AR content that has been aligned with the captured image displayed on the smartphone 1 to the user without causing a feeling of discomfort.

### Other Embodiments

Note that the respective display methods according to the embodiments described above may be switched by a user operation. For example, when the captured image and the AR content are displayed on the AR glasses 2 (the second embodiment), the captured image and the AR content may be switched to display on the smartphone 1 (the first embodiment) upon receipt of a user operation. Here, the user operation is an imaging operation or an imaging preparation operation such as zoom modification, for example.

Further, the display methods according to the respective embodiments may be modified on the basis of the distance or the positional relationship between the smartphone 1 and the AR glasses 2. For example, assuming that a camera is used as the imaging device 1, when the user looks through the EVF, as shown in FIG. 5B, the AR glasses 2 stop the display and the AR content is displayed on the smartphone 1 (the first embodiment). Meanwhile, when the user repositions the camera so as to look through the back surface liquid crystal, as shown in FIG. 5C, the smartphone 1 stops the display and the captured image and AR content are displayed on the AR glasses 2 (the second embodiment).

Thus, the method of displaying the captured image and the AR content can be switched between the embodiments on the basis of a user operation or the condition in which the user is viewing the display unit 107 of the smartphone 1 through the display unit 212 of the AR glasses 2.

According to the present disclosure, when a user wearing AR glasses views a display screen of an imaging device, AR content aligned with an image captured by the imaging device can be presented to the user without causing a feeling of discomfort.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-019734, filed on Feb. 10, 2021, which is hereby incorporated by reference herein in its entirety.

What is claimed is:

1. An imaging system including an imaging device and a display device that is a head-mounted device,
wherein the imaging device comprises at least one processor or at least one circuit which function as:
an imaging unit configured to control an image sensor; and
a display control unit configured to display a captured image captured by the image sensor and an object existing in a virtual space,
wherein the display device comprises at least one processor or at least one circuit which function as a display control unit to display the object, and
wherein, when a display of the imaging device is viewed through the display device,
one of the display control unit of the imaging device and the display control unit of the display device displays the object, which has been converted on the basis of information about an imaging state of the imaging device, and
the other of the display control unit of the imaging device and the display control unit of the display device does not display the object.

2. The imaging system according to claim 1, wherein the information about the imaging state includes at least one of attitude information of the imaging device, focal length information of the imaging device, and information indicating field depth of the imaging device.

3. The imaging system according to claim 1, wherein the at least one processor or the at least one circuit of the imaging device or the display device further function as a detection unit configured to detect that the display of the imaging device is being viewed through the display device.

4. The imaging system according to claim 1, wherein, when the display of the imaging device is being viewed through the display device,
the display control unit of the display device stops displaying the object, and
the display control unit of the imaging device displays a superimposed image in which the object, which has converted on the basis of the information about the imaging state, is superimposed on the captured image on the display of the imaging device.

5. The imaging system according to claim 1, wherein, when the display of the imaging device is being viewed through the display device,
the display control unit of the imaging device stops displaying the captured image and the object on the display of the imaging device, and
the display control unit of the display device displays a superimposed image in which the object, which has converted on the basis of the information about the imaging state, is superimposed on the captured image.

6. The imaging system according to claim 5, wherein the at least one processor or the at least one circuit of the imaging device further function as communicating unit configured to control of transmitting the captured image and the information about the imaging state to the display device,
wherein the at least one processor or the at least one circuit of the display device further function as communicating unit configured to control of receiving the captured image and the information about the imaging state from the imaging device, and
wherein the display control unit of the display device displays a superimposed image in which the object, which has been converted on the basis of the information about the imaging state, received from the imaging device, is superimposed on the captured image received from the imaging device.

7. The imaging system according to claim 5, wherein the display control unit of the display device displays a superimposed image in which the object, which has been converted on the basis of attitude information of the display device and the information about the imaging state, is superimposed on the captured image.

8. The imaging system according to claim 1, wherein, when the display of the imaging device is being viewed through the display device,
the display control unit of the imaging device stops displaying the object and displays the captured image on the display of the imaging device, and
the display control unit of the display device displays the object converted on the basis of the information about the imaging state.

9. The imaging system according to claim 8, wherein the at least one processor or the at least one circuit of the imaging device further function as a communicating unit configured to control of transmitting the information about the imaging state to the display device,
wherein the at least one processor or the at least one circuit of the display device further function as a communicating unit configured to control of receiving the information about the imaging state from the imaging device, and
wherein the display control unit of the display device displays the object that has been converted on the basis of the information about the imaging state, received from the imaging device.

10. The imaging system according to claim 8, wherein the display control unit of the display device displays the object that has been converted on the basis of attitude information of the display device and the information about the imaging state.

11. The imaging system according to claim 1, wherein blurring of the object caused by movement of the display device is corrected on the basis of attitude information of the display device, and
blurring of the object is further corrected on the basis of at least one of attitude information and focal length information of the imaging device and information indicating field depth of the imaging device.

12. The imaging system according to claim 1, wherein the display control unit of the imaging device and the display control unit of the display device switch between display and non-display of the captured image and the object on the basis of a user operation or a condition in which the display of the imaging device is being viewed through the display device.

13. A display device that is a head-mounted device and communicates with an imaging device, the display device comprising at least one processor or at least one circuit which function as:
a display control unit configured to display an object existing in a virtual space; and
a detection unit configured to detect the imaging device,
wherein, when the detection unit detects the imaging device, the display control unit modifies a display state of the object.

14. The display device according to claim 13, wherein, when the detection unit detects the imaging device, the display control unit stops displaying the object.

15. The display device according to claim 13, wherein, when the detection unit detects the imaging device, the display control unit displays the object, which has been converted on the basis of information about an imaging state of the imaging device.

16. An imaging device that communicates with a display device that is a head-mounted device, the imaging device comprising at least one processor or at least one circuit which function as:
an imaging unit configured to control an image sensor;
a display control unit configured to display a captured image captured by the image sensor and an object existing in a virtual space; and
a detection unit configured to detect the display device,
wherein, when the detection unit detects the display device, the display control unit stops displaying the object.

17. The imaging device according to claim 16, wherein, when the detection unit detects the display device, the display control unit stops displaying the captured image and the object.

18. A control method for an imaging system including an imaging device and a display device that is a head-mounted device, the control method comprising:
displaying, by the imaging device, a captured image captured by an image sensor of the imaging device and an object existing in a virtual space; and
displaying the object by the display device,
wherein, when a display of the imaging device is being viewed through the display device,
one of the imaging device and the display device displays the object, which has been converted on the basis of information about an imaging state of the imaging device, and
the other of the imaging device and the display device does not display the object.

19. A non-transitory computer readable medium that stores a program, wherein the program causes an imaging system, which includes an imaging device and a display device that is a head-mounted device, to execute:
displaying, by the imaging device, a captured image captured by an image sensor of the imaging device and an object existing in a virtual space; and
displaying the object by the display device,
wherein, when a display of the imaging device is being viewed through the display device,
one of the imaging device and the display device displays the object, which has been converted on the basis of information about an imaging state of the imaging device, and
the other of the imaging device and the display device does not display the object.
